(19) United States
(12) Patent Application Publication
(10) Pub. No.: US 2018/0244001 A1
(43) Pub. Date: Aug. 30, 2018

(54) METHOD FOR APPLYING PATCHES TO HELMET COVERS

(71) Applicant: Inanc Sener, West Palm Beach, FL (US)

(72) Inventor: Inanc Sener, West Palm Beach, FL (US)

(21) Appl. No.: 15/951,983

(22) Filed: Apr. 12, 2018

Related U.S. Application Data
(63) Continuation-in-part of application No. 15/239,952, filed on Aug. 18, 2016.

(51) Int. Cl. B29C 73/10; B29C 65/18; B29C 65/00

(52) U.S. Cl. CPC B29C 73/10; B29C 65/18; B29C 66/474; B29C 66/7294; B29L 2031/4821; B29K 2913/00; B29K 2995/003; B29K 2995/0046; B29C 66/71

(57) ABSTRACT

A template made of plexiglass or similar material is inserted into a cover for a protective helmet so that the cover is stretched and once the template is inserted the assembled combination of the cover and the template is oval-shaped. The oval-shaped assembly is placed on top of the bottom plate of a heat press. A layer with a decal or sticker is placed on top of the oval-shaped assembly. A heat press cover sheet is then placed on top of the oval-shaped assembly so that it also becomes into contact with the top plate of the heat press when the heat press is closed. The heat press may be set to a temperature of at least 350 degrees Fahrenheit and it can be set in a closed position for at least 10 seconds in order to transfer sufficient heat so that the decal or sticker is applied or affixed to the cover surface.

### TECHNICAL FIELD

The present invention relates to protective helmets. More specifically, the present invention relates to applying or affixing patches to covers for protective helmets.

### BACKGROUND

As is known, protective helmets are utilized in a variety of activities in order to protect the wearer from head trauma injuries. For example, protective helmets are commonly used by persons engaged in bicycle and motorcycle riding, skiing, snowboarding, auto racing, football, hockey, and other activities in which there is a reasonably high likelihood of head trauma injuries if the head is not protected.

Although such helmets are designed to protect the wearer's head in case of an impact, it is not uncommon for such helmets to be decorated on their exterior surfaces in order to have a pleasing appearance or to allow the wearer to be readily identified at a distance. Therefore, although protective helmets are designed to absorb the force of an impact in the event of a crash, most owners of protective helmets do not expect to be involved in such crashes during the normal course of their activities, and therefore they generally desire to keep the helmets in an attractive, unblemished condition.

Maintaining the protective helmets in an unblemished condition is made difficult by the fact that the helmets tend to be bulky and may not be easily stored during periods of non-use, including transport to and from the activity where the helmet may be required, and during breaks in the activity (during which most wearers do not wish to hold the helmet with their hands or wear the helmet). It has therefore been found that the decorative exterior surface of the helmet will generally become marred and damaged over time due to coming into contact with other objects during such storage and transport. Such damage can also have an effect upon the impact absorption performance of the helmet. Most manufacturers of protective helmets caution that a helmet should not be worn if its surface has been damaged, as the structural integrity of the helmet may have been compromised. Helmet covers have been developed and are currently used to protect helmets from damage.

Known covers for protective helmets, while adequate to protect the helmets from wear and tear, suffer from a number of shortcomings. For example, currently known helmet covers include those made from leather or vinyl, often with a faux-fur or wool lining. These covers are nearly as heavy and as bulky as the helmet they cover and present a storage and transport problem when not in use. Further, these covers are difficult to clean and dry, as they retain moisture and may develop mildew once they become wet.

Nylon helmet covers are not as heavy and/or bulky as their leather and vinyl counterparts, but instead tend to bag around the helmet such that they are readily snagged and torn. Further, covers made of lycra blends can also be torn or damaged.

There is therefore a need for systems, methods, or devices that will allow for applying or affixing patches to damaged covers for protective helmets.

### SUMMARY

The following presents a simplified summary of the invention in order to provide a basic understanding of some aspects of the invention. This summary is not an extensive overview of the invention. Rather than specifically identify key or critical elements of the invention or to delineate the scope of the invention, its purpose, inter alia, is to present some concepts of the invention in a simplified form as a prelude to the more detailed description that is presented later.

In one embodiment of the present disclosure, a template made of plywood or similar material is inserted into a cover for a protective helmet so that the cover is stretched and once the template is inserted the assembled combination of the cover and the template resembles the shape of a disk. In another embodiment, the template may be made of plexiglass plastic and may be oval-shaped. The disk-shaped or oval-shaped assembly is placed on top of the bottom plate of a heat press. A layer with a decal or sticker is placed on top of the disk-shaped or oval-shaped assembly. A heat press cover sheet is then placed on top of the disk-shaped or oval-shaped assembly so that it also becomes into contact with the top plate of the heat press when the heat press is closed. The heat press may be set to a temperature of at least 350 degrees Fahrenheit and it can be set in a closed position for about 30 seconds in order to transfer sufficient heat so that the decal or sticker is applied or affixed to the cover surface.

The following description and the accompanying drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following description of the invention when considered in conjunction with the drawings.

### BRIEF DESCRIPTION OF THE DRAWINGS

The embodiments of the present disclosure will now be described by reference to the following figures:

FIG. 1 illustrates a cover for a helmet which has been damaged;

FIG. 2 illustrates an exemplary clamp heat press for use in the method disclosed;

FIG. 3 illustrates one aspect of the method for applying or affixing decals or stickers to a helmet cover in accordance with one implementation; and

FIG. 4 illustrates another aspect of the method for applying or affixing decals or stickers to a helmet cover in accordance with one implementation.

### DETAILED DESCRIPTION

The following detailed description and the appended drawings describe and illustrate exemplary embodiments of the invention solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present disclosure, such as conventional details of fabrication and assembly.

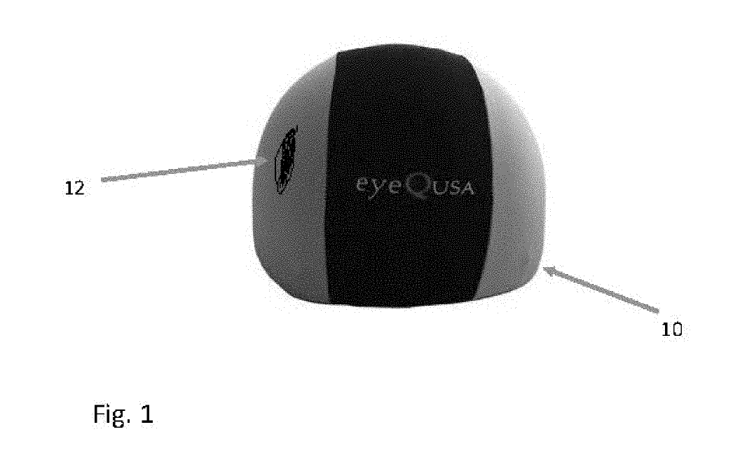

FIG. 1 illustrates a cover 10 for a helmet which has been damaged 12. In one implementation, the cover may be made from lycra, a lycra blend, spandex, neoprene material, fabrics that include elastane, stretch jean fabric, or any other type of elastic material. In one embodiment, the cover may be fabricated from a single piece of material. Alternatively, the cover may be fabricated by stitching together three pieces of material (of the same type of material or of different type of materials) to form the cover. In one embodiment, the cover includes elastic stitched or otherwise attached in the bottom of the cover to secure the cover to the helmet and thus reduce the likelihood that the cover will fly off when a user rides at a high speed. This elastic may be fabricated with reflective material.

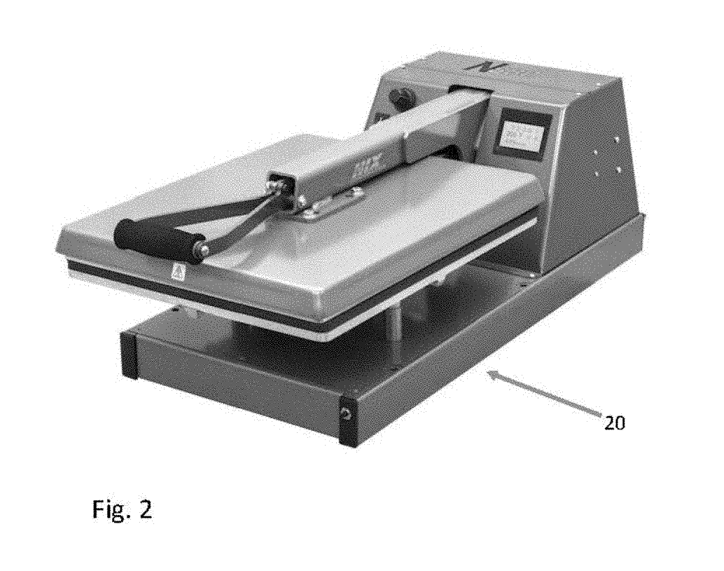

FIG. 2 illustrates an exemplary clamp heat press 20 for use in the method disclosed. In one implementation, the heat press may require an air compressor (not illustrated).

When the upper plate of the press 20 is pulled down, it stops as the upper plate becomes in close proximity to the bottom plate. When the two plates become in close proximity, the heat press 20 injects air from the air compressor. The injected air creates pressure that pushes the bottom plate up to clamp the two plates together. After a desired time cycle is completed (about 30 seconds in accordance with one implementation), the top plate is then opened up. In one implementation, the press 20 may be a clamp press manufactured by HIX Corporation, for example, model N-880.

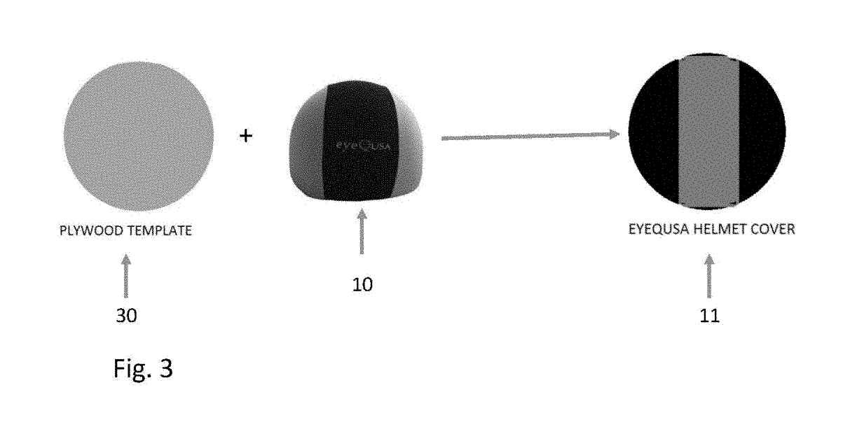

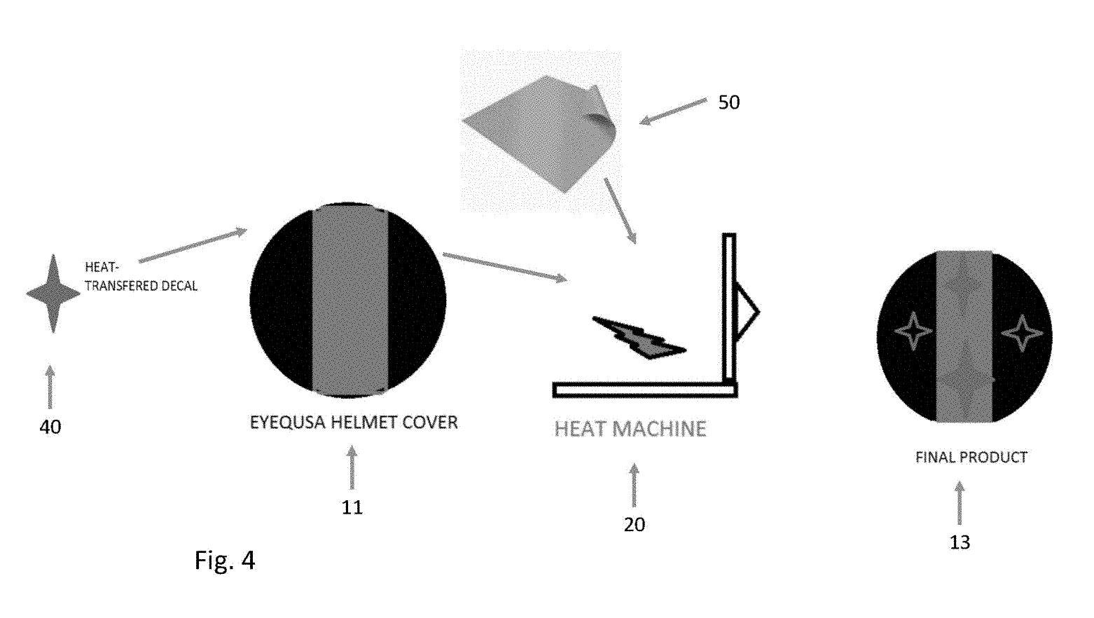

FIG. 3 illustrates one aspect of the method for applying or affixing decals or stickers 40 to a helmet cover 10 in accordance with one implementation. A template 30 made of plywood, plexiglass, or similar materials is inserted into the cover 10 for a protective helmet so that the cover 10 is stretched and once the template is inserted the assembled combination of the cover and the template resembles the shape of a disk or an oval. The template 30 may be of different shapes, depending on how far the cover 10 can stretch. Heat is then applied to the disk-shaped or oval-shaped assembly 11 to affix the stickers or decals 40 as described with reference to FIG. 4.

FIG. 4 illustrates another aspect of the method for applying or affixing decals or stickers 40 to a helmet cover 10 in accordance with one implementation. The disk-shaped or oval-shaped assembly 11 is placed on top of the bottom plate of a heat press 20. A layer with a decal or sticker 40 is placed on top of the disk-shaped or oval-shaped assembly. A heat press cover sheet 50 is then placed on top of the disk-shaped or oval-shaped assembly 11 so that it also becomes into contact with the top plate of the heat press 20 when the heat press is closed. The cover sheet 50 may be made out of felt and may be circular in shape or oval-shaped. The heat press 20 may be set to a temperature of 350 degrees Fahrenheit and it can be set in a closed position for about 30 seconds in order to transfer sufficient heat so that the decal or sticker 40 is applied or affixed to the surface of the cover 10. A person of ordinary skill in the art would recognize that as little as 10 seconds of heat application may suffice and that the temperature range can vary depending on the material used for the patches.

FIG. 4 also illustrates the final product 13 which is the cover 10 with the stickers or decals 40 attached thereto after the template 30 has been removed from inside the cover 10. The stickers or decals may serve as patches to cover sections 11 of the helmet cover 10 that have been damaged. The stickers or decals may also cover the entire cover or only a portion of the cover. In an alternative implementation, the stickers or decals may be applied for decorative purposes and they may incorporate or may be used to attach rhinestones (e.g., through transfer printing), LED lights (sewn or glued), reflective material, leather patches, etc. The stickers or decals may also include embroidery, and may be spray painted, stamp painted, hand painted, screen printed, fusion printed, laser printed, sublimation printed, or be applied any kind of printing, and may be used on any type of lycra or similar fabric jean material. In another implementation, the stickers or decals may be applied to helmet covers made out of leather, linen, polyester, cotton, jean material, and others. In yet another implementation, 3D paint or any other kind of paint or print design may be applied to the patch before being applied to the cover, and such painting or print designs may also be applied to the cover directly. As an alternative to the use of the heat press, water transfer printing films or techniques may be used. As yet another alternative to the use of heat press, the decals or patches may be attached to the helmet cover through the use of hook and loop straps or by sewing the decals or patches on the cover.

In one embodiment, the decal or patch may be applied to the material used to make the cover before the cover is assembled in accordance with the methods described herein. Once the patch or decal has been applied to the cover material, the cover may be assembled by stitching or by applying other techniques. In one embodiment, the cover, when assembled after the decal or patch has been applied, includes elastic stitched or otherwise attached in the bottom of the cover to secure the cover to the helmet and thus reduce the likelihood that the cover will fly off when a user rides at a high speed.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to illustrate aspects of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. 112(f) unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A method for applying patches to a helmet cover, the method comprising:
inserting a template made out of plexiglass into a cover for a protective helmet so that the cover is stretched and once the template is inserted into the cover it forms an oval-shaped assembly;
placing the oval-shaped assembly on top of a bottom plate of a heat press;
placing a patch on top of the oval-shaped assembly;
placing a heat press cover sheet on top of the oval-shaped assembly;
pulling down an upper plate of the heat press so that the heat press cover sheet makes contact with the upper plate of the heat press when the heat press is closed; and
pulling up the upper plate.

2. A method according to claim 1, further including:
preheating the heat press to a temperature of at least 350 degrees Fahrenheit, wherein the step of pulling up the upper plate is performed for at least 10 seconds after the upper plate has been pulled down.

3. A method according to claim 1, wherein said cover sheet is made out of felt.

4. A method according to claim 1, further comprising incorporating rhinestones to the patch through transfer printing.

5. A method according to claim 1, further comprising incorporating LED lights to the patch by gluing or sewing the lights to the patch.

6. A method according to claim 1, wherein said patch incorporates embroidery.

7. A method according to claim 1, wherein said patch may be spray painted, stamp painted, hand painted, screen printed, fusion printed, laser printed, or sublimation printed.

8. A method according to claim 1, wherein said cover incorporates at least one of elastane, neoprene, or stretch jean fabric or material.

9. A method according to claim 1, wherein said cover includes elastic in the bottom of the cover.

10. A method according to claim 1, wherein said cover sheet is oval-shaped.

11. A method according to claim 1, wherein said template sheet is oval-shaped.

12. A method according to claim 1, wherein said elastic is fabricated with reflective material.

13. A method according to claim 1, further comprising incorporating reflective material to the patch.
